(19) United States
(12) Patent Application Publication
(10) Pub. No.: US 2025/0103328 A1
(43) Pub. Date: Mar. 27, 2025

(54) Streaming-based Computation Circuit, Method and Artificial Intelligence Chip

(71) Applicant: Shenzhen Corerain Technologies Co., Ltd., Shenzhen (CN)

(72) Inventors: Li Jiao, Shenzhen, Guangdong (CN); Kuen Hung Tsoi, Shenzhen, Guangdong (CN); Xinyu Niu, Shenzhen, Guangdong (CN)

(21) Appl. No.: 18/650,527

(22) Filed: Apr. 30, 2024

(30) Foreign Application Priority Data
Sep. 26, 2023 (CN) 202311246537.1

(51) Int. Cl. G06F 9/30; G06F 17/16

(52) U.S. Cl. CPC G06F 9/3001; G06F 17/16

(57) ABSTRACT

The present disclosure provides a streaming-based computation circuit, method and artificial intelligence chip. The computation circuit includes: multiple groups of computation units. Multiple groups of computation units include a first group of computation units and a second group of computation units, the second group of computation units is configured to output a first matrix after each calculation; and a buffer unit, configured to perform one or more first operation. The first operations include: buffering M first matrices consecutively outputted by the second group of computation units for M times, concatenating the M first matrices into a second matrix, the number of elements in the second matrix is not greater than the calculation parallelism of the first computation unit in the first group of computation units, and consecutively outputting the second matrix to the first computation unit for N times to perform N calculation.

### CROSS REFERENCE TO RELATED APPLICATIONS

The present application claims the benefit of Chinese Patent Application No. 202311246537.1 filed on Sep. 26, 2023, the contents of which are incorporated herein by reference in their entirety.

### TECHNICAL FIELD

The present disclosure relates to the field of artificial intelligence technology, and in particular to a streaming-based computation circuit, method and artificial intelligence chip.

### BACKGROUND TECHNIQUE

Currently, various artificial intelligence algorithms have been widely used in various fields. For example, neural network algorithms have been widely used in machine vision fields such as image recognition and image classification.

To address issues such as high computational complexity, large computational workload, and long processing times of artificial intelligence algorithms, artificial intelligence chips (i.e., AI chips) can be utilized to accelerate the execution of these algorithms.

In the realm of related technologies, there are two main types of artificial intelligence chips: those based on instruction set architecture and those based on data flow architecture.

Due to the relatively mature architecture and well-established ecosystem, the majority of current artificial intelligence chips are based on instruction set architecture.

The streaming architecture is an innovative architecture established in recent years based on Domain Special Architecture (DSA) theory. It combines the task characteristics of artificial intelligence algorithms for targeted optimization and performs pipelined processing of input data according to a streaming approach, resulting in significant improvements in performance and computational efficiency.

### Contents of the Invention

The inventor noticed that the computational efficiency of streaming-based artificial intelligence chips is still low in certain scenarios.

The analysis revealed that multiple computation units within this artificial intelligence chip can have different calculation parallelism. In certain scenarios, computation units with a lower calculation parallelism perform calculations prior to those with a higher calculation parallelism. In this case, the amount of data to be calculated fed into the computation units with higher calculation parallelism is lesser than the calculation parallelism of the computation units, leading to idle operators within the computation units and subsequently reducing computational efficiency.

In order to solve the above problems, embodiments of the present disclosure provide the following technical solutions.

According to an aspect of an embodiment of the present disclosure, a streaming-based computation circuit is provided, including:
multiple groups of computation units, each group of computation units including one or more computation units, the multiple groups of computation units including a first group of computation units and a second group of computation units, the second group of computation units being configured to output a first matrix after each calculation; and
a buffer unit configured to perform one or more first operations, wherein the first operations include:
buffering M first matrices consecutively outputted by the second group of computation units for M times, wherein M is an integer greater than or equal to 2;
concatenating the M first matrices into a second matrix, a number of elements in the second matrix is not greater than a calculation parallelism of a first computation unit in the first group of computation units; and
consecutively outputting the second matrix to the first computation unit for N times to perform N calculations, wherein N is an integer greater than or equal to 2.

In some embodiments, the number of elements in the second matrix is equal to the calculation parallelism.

In some embodiments, Nis an integer not less than M.

In some embodiments, N equals M.

In some embodiments, the buffer unit is further configured to perform a second operation, the second operation including:
directly outputting a received third matrix to the first computation unit to perform a calculation, wherein a number of elements in the third matrix is equal to the calculation parallelism.

In some embodiments, the buffer unit includes:
a first buffer configured to perform the first operations; and
a second buffer configured to output a fourth matrix required for a single calculation to the first computation unit each time the first buffer outputs the second matrix to the first computation unit to perform the single calculation.

In some embodiments, the computation circuit further includes:
a first selection unit including a first input end, a second input end, a first output end and a second output end, wherein:
the first input end is configured to be connected to any one of the first output end and
the second output end,
the second input end is configured to be connected to the first output end,
the first output end is configured to be connected to an input end of the buffer unit;
a second selection unit including a third input end, a fourth input end, a third output end and a fourth output end, wherein:
the third input end is configured to be connected to an output end of the first group of computation units, and is further configured to be connected to any one of the third output end and the fourth output end,
the fourth input end is configured to be connected to the second output end, and is further configured to be connected to the third output end,
the third output end is configured to be connected to an input end of the second group of computation units; and
a third selection unit including a fifth input end, a fifth output end and a sixth output end, wherein:
the fifth input end is configured to be connected to an output end of the second group of computation units, and further configured to be connected to any one of the fifth output end and the sixth output end,
the fifth output end is configured to be connected to the second input end.

In some embodiments, the first selection unit includes:
a first distributor including the first input end, the second output end and a first intermediate output end, the first input end being configured to be connected to any one of the second output end and the first intermediate output end, and
a first selector including a first intermediate input end, the second input end and the first output end, the first intermediate input end being configured to be connected to the first intermediate output end, the first output end being configured to be connected to any one of the first intermediate input end and the second input end; the second selection unit includes:
a second distributor including the third input end, a second intermediate output end and the fourth output end, the third input end being configured to be connected to any one of the second intermediate output end and the fourth output end, and
a second selector including the fourth input end, a second intermediate input end and the third output end, the second intermediate input end being configured to be connected to the second intermediate output end, the third output end being configured to be connected to any one of the fourth input end and the second intermediate input end;
the third selection unit includes:
a third distributor including the fifth input end, the fifth output end, and the sixth output end.

In some embodiments, the first group of computation units and the second group of computation units include computation units configured to perform a same type of artificial intelligence calculations, and further include computation units configured to perform different types of artificial intelligence calculations.

In some embodiments, the same type of artificial intelligence calculations includes a linear calculation.

In some embodiments, the first group of computation units includes:
the first computation unit configured to perform a kernel function calculation;
a second computation unit configured to perform an activation function calculation;
a third computation unit configured to perform a linear calculation; and
a fourth computation unit configured to perform a pooling calculation.

In some embodiments, the second group of computation units includes:
a fifth computation unit configured to perform a linear calculation; and
a sixth computation unit configured to perform a reduction function calculation.

In some embodiments, a number of columns of the second matrix is K times a number of columns of the first matrix, K is an integer greater than or equal to 2, and each row of the second matrix includes K-row elements of the first matrix.

According to another aspect of an embodiment of the present disclosure, a streaming-based computation method is provided, including:
buffering M first matrices consecutively outputted by a second group of computation units of a streaming-based computation circuit for M times, M being an integer greater than or equal to 2;
concatenating the M first matrices into a second matrix, a number of elements in the second matrix being not greater than a calculation parallelism of a first computation unit in the first group of computation units of the computation circuit; and consecutively outputting the second matrix to the first computation unit for N times to perform N calculation, N being an integer greater than or equal to 2;
wherein, the first group of computation units and the second group of computation units each include one or more computation units.

In some embodiments, the number of elements in the second matrix is equal to the calculation parallelism.

In some embodiments, N is an integer not less than M.

In some embodiments, N equals M.

According to yet another aspect of an embodiment of the present disclosure, an artificial intelligence chip is provided, including:
the streaming-based computation circuit according to any one of the embodiments.

According to still another aspect of an embodiment of the present disclosure, an electronic device is provided, including:
the artificial intelligence chip according to any one of the embodiments.

In the streaming-based computation circuit provided by the embodiment of the present disclosure, the second group of computation units with lower calculation parallelism continuously outputs M first matrices, which are then concatenated into a second matrix containing a number of elements less than or equal to the calculation parallelism of the first computation unit. Subsequently, the concatenated second matrix is consecutively outputted to the first computation unit for N times to perform N calculations. On the one hand, the second matrix obtained by concatenating M first matrices is outputted to the first computation unit to perform calculation, instead of directly outputting one first matrix each time outputted by the second group of computation units to the first computation unit to perform calculation. This can improve the utilization of the operators in the first computation unit. On the other hand, by consecutively outputting the second matrix to the first computation unit for N times to perform N calculations, instead of only outputting the second matrix to the first computation unit to perform one calculation, it can continuous to receive at least a part of the M first matrices from the next first operation during consecutive outputting of the second matrix to the first computation unit for N times, so that after consecutively outputting the second matrix from the previous first operation to the first computation unit for N times, it can quickly start to output the second matrix from the next first operation to the first computation unit for calculation. In this way, computational efficiency can be improved.

Other features, aspects, and advantages of the present disclosure will become apparent from the following detailed description of exemplary embodiments of the present disclosure with reference to the accompanying drawings.

### DESCRIPTION OF THE DRAWINGS

The accompanying drawings, which constitute a part of this specification, illustrate exemplary embodiments of the disclosure and, together with the specification, serve to explain principles of the disclosure.

The present disclosure may be more clearly understood from the following detailed description, with reference to the accompanying drawings, in which:

FIG. 1 is a structural schematic diagram of a streaming-based computation circuit according to some embodiments of the present disclosure;

FIG. 2 is a schematic flowchart of a streaming-based computation method according to some embodiments of the present disclosure;

FIG. 3 is a structural schematic diagram of a streaming-based computation circuit according to other embodiments of the present disclosure;

FIG. 4 is a structural schematic diagram of a streaming-based computation circuit according to some embodiments of the present disclosure;

FIG. 5A is a structural schematic diagram of a streaming-based computation circuit according to some embodiments of the present disclosure;

FIG. 5B is a structural schematic diagram of a streaming-based computation circuit according to some embodiments of the present disclosure;

FIG. 6 schematically shows some calculations in the Transformer algorithm;

FIG. 7 shows a structural schematic diagram of a streaming-based computation circuit in the related art; and

FIG. 8 is a schematic diagram of matrices required to perform matrix multiplication calculations in accordance with some embodiments of the present disclosure.

It should be understood that the dimensions of the various components shown in the drawings are not necessarily drawn to actual proportions. In addition, the same or similar reference numbers indicate the same or similar components.

### DETAILED DESCRIPTIONS

Various exemplary embodiments of the present disclosure will now be described in detail with reference to the accompanying drawings. The description of the exemplary embodiments is illustrative only and is in no way intended to limit the disclosure and its application or uses. The present disclosure may be implemented in many different forms and is not limited to the embodiments described herein. These embodiments are provided so that this disclosure will be thorough and complete, and will fully convey the scope of the disclosure to those skilled in the art. It should be noted that, unless specifically stated otherwise, the relative arrangements of parts and steps, compositions of materials, numerical expressions, and numerical values set forth in these examples are to be construed as illustrative only and not as limitations.

“First”, “second”, and similar words used in this disclosure do not indicate any order, quantity, or importance, but are merely used to distinguish different parts. Similar words such as “comprise” or “include” mean that the elements before the word include the elements listed after the word, and do not exclude the possibility of also covering other elements. “Up”, “down”, etc. are only used to express relative positional relationships. When the absolute position of the described object changes, the relative positional relationship may also change accordingly.

In this disclosure, when a specific component is described as being between a first component and a second component, there may or may not be an intervening component between the specific component and the first component or the second component. When a specific component is described as being connected to other components, the specific component may be directly connected to the other components without intervening components, or may not be directly connected to the other components but have intervening components.

All terms (including technical terms or scientific terms) used in this disclosure have the same meanings as understood by those ordinary skilled in the art to which this disclosure belongs, unless otherwise specifically defined. It should also be understood that terms defined in, for example, general dictionaries should be construed to have meanings consistent with their meanings in the context of the relevant technology and should not be interpreted in an idealized or highly formalized sense, except as expressly stated herein.

Techniques, methods and devices known to those ordinary skilled in the relevant art may not be discussed in detail, but where appropriate, such techniques, methods and devices should be considered a part of the specification.

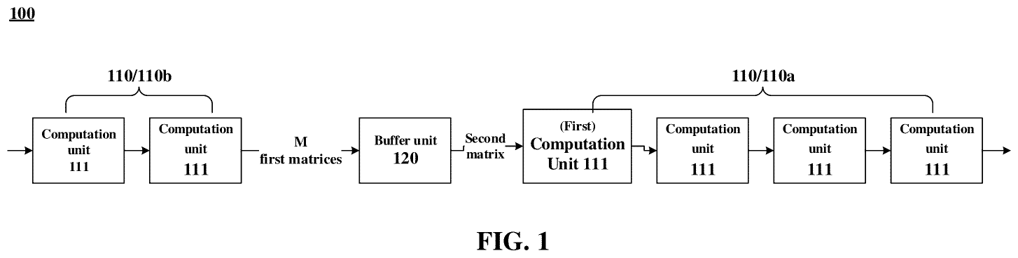

FIG. 1 is a structural schematic diagram of a streaming-based computation circuit according to some embodiments of the present disclosure.

As shown in FIG. 1, the streaming-based computation circuit 100 includes a plurality of groups of computation units 110. Each group of computation units 110 includes one or more computation units 111. Each computation unit 111 may be configured to perform one type of artificial intelligence calculation.

Types of artificial intelligence calculations can include, but are not limited to, kernel function (Kernel) calculations, activation function (Activation) calculations, linear (Linear) calculations, pooling (Pool) calculations, and reduction function (Reduce) calculations, etc. Kernel function calculation may be, for example, tensor calculation, and tensor calculation may include but is not limited to convolution calculation. Linear calculations may include but are not limited to binary operation (i.e. Shortcut) calculations. Reduction function calculations may include but are not limited to Global Average Pooling (GAP) calculations.

Each computation unit 111 may include a specific operator to perform a corresponding type of artificial intelligence calculation. Different computation units 111 may include the same or different operators.

For example, the computation unit 111 configured to perform kernel function calculation (hereinafter referred to as the kernel function computation unit) includes a plurality of multipliers and a plurality of adders.

For another example, the computation unit 111 configured to perform activation function calculation (hereinafter referred to as activation function computation unit) includes multiple arithmetic and logic units (Arithmetic and Logic Unit, ALU). The arithmetic and logic unit may be configured to perform various operations, including multiplication, addition, as well as more complex operations like exponentiation and division.

For yet another example, the computation unit 111 configured to perform pooling calculations (hereinafter referred to as the pooling computation unit) includes a plurality of comparators.

For still another example, the computation unit 111 configured to perform linear calculations (hereinafter referred to as the linear computation unit) includes a plurality of multipliers and a plurality of adders. As some implementations, the number of multipliers and adders in the linear computation unit 111 may be smaller than the number of multipliers and adders in the kernel function computation unit 111.

For still another example, the computation unit 111 configured to perform reduction function calculation (hereinafter referred to as the reduction function computation unit) includes an accumulator and a counter to perform accumulation operations and averaging operations.

The plurality of groups of computation units 110 includes a first group of computation units 110a and a second group of computation units 110b. It is schematically shown in FIG. 1 that the first group of computation units 110a includes 4 computation units 111 and the second group of computation units 110b includes 2 computation units 111. It should be understood that the multiple groups of computation units 110 may also include other groups of computation units not shown in FIG. 1.

The second group of computation units 110b is configured to output the first matrix after each calculation.

As some implementations, the second group of computation units 110b may be configured to obtain data to be calculated from other groups of computation units not shown in the computation circuit 100 and perform calculations on the data to be calculated to output the first matrix. As other implementations, the second group of computation units 110b may be configured to obtain data to be calculated from a storage unit external to the computation circuit 100 and perform calculations on the data to be calculated to output the first matrix.

It should be understood that in the case where the second group of computation units 110b includes multiple computation units 111. For different calculation requirements, the first matrix outputted by the second group of computation units 110b after each calculation can be generated by different computation units 111 in the second group of computation units 110b.

For example, the second group of computation units 110b includes the two computation units 111 shown in FIG. 1.

For certain calculation requirements, the first matrix is generated by the first computation unit 111 of the two computation units 111. That is, under these calculation requirements, only the first computation unit 111 participates in the calculation.

For other calculation requirements, the first matrix is generated by the second computation unit 111 of the two computation units 111. That is, under these calculation requirements, only the second computation unit 111 participates in calculations.

For yet other calculation requirements, the first matrix is collaboratively generated by two computation units 111. That is, under these calculation requirements, the two computation units 111 jointly participate in calculations, for example, perform calculations in sequence.

As shown in FIG. 1, the streaming-based computation circuit 100 further includes a buffer unit 120. The buffer unit 120 is configured to perform one or more first operations. For example, the buffer unit 120 may be configured to consecutively perform the first operation multiple times.

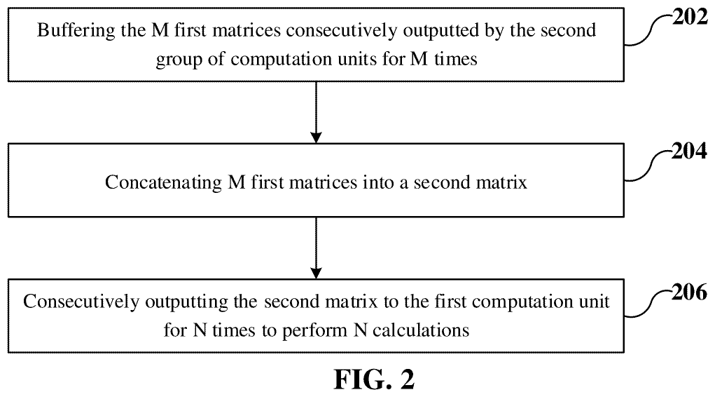

The first operation will be described below in conjunction with the streaming-based computation method shown in FIG. 2. FIG. 2 is a schematic flowchart of a streaming-based computation method according to some embodiments of the present disclosure.

As shown in FIG. 2, the streaming-based computation method (that is, the first operation) includes steps 202 to 206.

In step 202, M first matrices consecutively outputted by the second group of computation units 110b for M times are buffered.

Here, M is an integer greater than or equal to 2. In other words, in step 202, a plurality of first matrices consecutively outputted by the second group of computation units 110b for multiple times are buffered.

In step 204, M first matrices are concatenated into a second matrix.

The number of elements in the second matrix is not greater than (that is, less than or equal to) the calculation parallelism of the first computation unit 111 in the first group of computation units 110a. For example, the first group of computation units 110a includes a plurality of computation units 111 connected in sequence. In this case, the first computation unit 111 may be the first computation unit among the plurality of computation units 111.

The number of elements in the second matrix, which is formed by concatenating multiple first matrices, is not greater than the calculation parallelism of the first computation unit 111 in the first group of computation units 110a. Specifically, the number of elements in the first matrix is not greater than ½ of the calculation parallelism of the first computation unit 111. Furthermore, the calculation parallelism of each computation unit 111 in the second group of computation units 110b is not greater than ½ of the calculation parallelism of the first computation unit 111.

For example, the calculation parallelism of each computation unit 111 in the second group of computation units 110b is 64 bytes (Byte, B), and the calculation parallelism of the first computation unit 111 is 256B. In this case, the number of elements in the first matrix is 64, and the number of elements in the second matrix is less than or equal to 256. In other words, in this case, the second matrix can be obtained by concatenating 2 to 4 first matrices.

In step 206, the second matrix is consecutively outputted to the first computation unit 111 for N times to perform N calculations.

Here, N is an integer greater than or equal to 2. In other words, in step 206, the second matrix is consecutively outputted to the first computation unit for multiple times to perform multiple calculations.

In some embodiments, the number of elements in the second matrix is less than the calculation parallelism of the first computation unit 111. In this case, a zero-padding operation may be performed on the second matrix to obtain a matrix including the second matrix (hereinafter referred to as the fifth matrix). The number of elements in the fifth matrix is equal to the calculation parallelism of the first computation unit 111.

In these embodiments, the fifth matrix may be consecutively outputted to the first computation unit 111 for N times to perform N calculations, thereby implementing the step of consecutively outputting the second matrix to the first computation unit 111 for N times to perform N calculations.

Since the computation circuit 100 is based on the streaming architecture, during the period when the buffer unit 120 consecutively outputs the second matrix to the first computation unit 111 for N times, the second group of computation units 110b can also continue to output N consecutive first matrices (i.e., the second group of computation units 110b continues to output N first matrices after consecutively outputting M first matrices). In other words, during the period when the buffer unit 120 consecutively outputs the second matrix for N times, it can also continue to receive and buffer the N first matrices consecutively outputted by the second group of computation unit 110b for N times.

It can be understood that N is not greater than the number of times the second matrix needs to be calculated by the first computation unit 111.

If N is less than M, when the second matrix has been consecutively outputted to the first computation unit 111 for N times, the buffer unit 120 only receives N first matrices among the M first matrices in the next first operation. In this case, the buffer unit 120 may wait until it receives the M first matrices in the next first operation, and then repeat steps 204 to 206.

If N is not less than M, when the second matrix has been consecutively outputted to the first computation unit 111 for N times, the buffer unit 120 has received M first matrices in the next first operation. In this case, the buffer unit 120 can repeat steps 204 to 206 based on having received the M first matrices in the next first operation without additional waiting.

In the streaming-based computation circuit and computation method of the above embodiment, the M first matrices consecutively outputted by the second group of computation units 110b with a smaller calculation parallelism for M times are concatenated into the second matrix with the number of elements less than or equal to the calculation parallelism of the first computation unit 111. Then, the concatenated second matrix is consecutively outputted to the first computation unit for N times to perform N calculations. On the one hand, the second matrix obtained by concatenating M first matrices is outputted to the first computation unit 111 to perform calculations, instead of directly outputting one first matrix each time outputted by the second group of computation units 110b to the first computation unit 111 for calculation, which can improve the utilization of the operator in the first computation unit 111. On the other hand, consecutively outputting the second matrix to the first computation unit 111 for N times to performs N calculations, instead of only outputting the second matrix to the first computation unit 111 to perform one calculation, which can continue to receive at least a part of the M first matrices in the next first operation during the consecutive N-time outputting of the second matrix to the first computation unit 111, so that after the second matrix in the previous first operation is consecutively outputted to the first computation unit 111 for N times, it can more quickly output the second matrix in the next first operation to the first computation unit 111 to perform calculation. In this way, the computational efficiency can be improved.

In addition, by adding the buffer unit 120 to the computation circuit 100 and configuring the buffer unit 120 to consecutively output the second matrix to the first computation unit 111 for N times to perform N calculations, the second matrix can be multiplexed inside the computation circuit 100, There is no need to read the second matrix N times from a storage unit external to the computation circuit 100, which is beneficial to reducing power consumption.

The streaming-based computation circuit 100 of the embodiment of the present disclosure will be further described below in conjunction with some embodiments.

In some embodiments, the buffer unit 120 is further configured to perform a second operation that is different from the first operation. Here, the second operation includes directly outputting the received third matrix to the first computation unit 111 to perform calculation. The number of elements in the third matrix is equal to the calculation parallelism of the first computation unit 111.

In other words, in these embodiments, when receiving the third matrix with the number of elements equal to the calculation parallelism of the first computation unit 111, the buffer unit 120 does not need to perform buffering concatenation, but directly outputs the third matrix to the first computation unit 111 to perform calculation.

Since the number of elements in the third matrix is equal to the calculation parallelism of the first computation unit 111, even if the buffer unit 120 directly outputs the third matrix to the first computation unit 111 to perform calculation without performing other additional processing, the operators in the first computation unit 111 can also reach the maximum utilization rate. In this way, the processing load on the buffer unit 120 can be reduced, thereby reducing the possibility of failure of the buffer unit 120, and thus enhancing the reliability of the computation circuit 100.

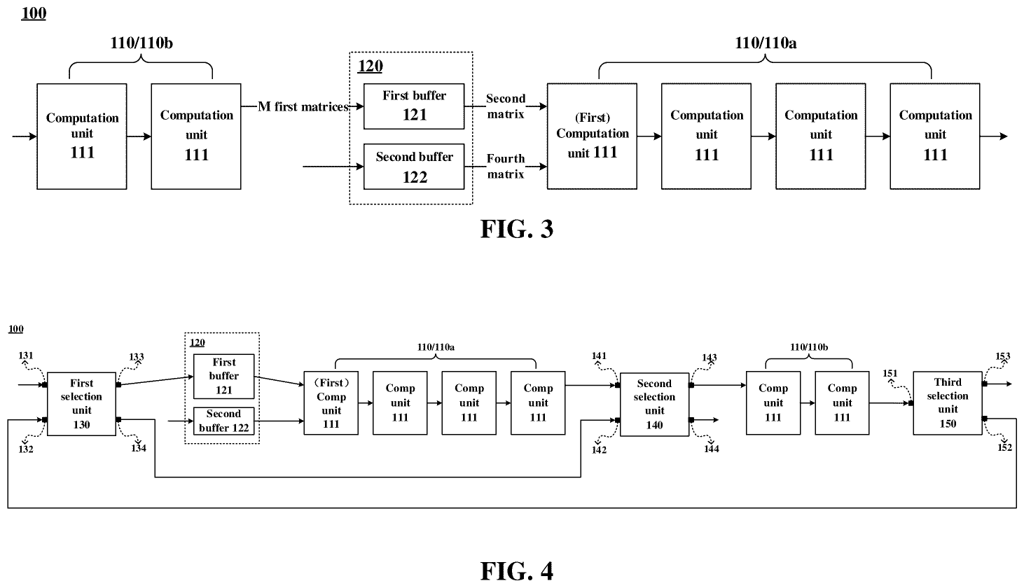

In some embodiments, the first computation unit 111 requires two matrices (i.e., a second matrix and a fourth matrix other than the second matrix) to perform calculations. In this case, the structure of the buffer unit 120 may be as shown in FIG. 3.

FIG. 3 is a structural schematic diagram of a streaming-based computation circuit according to other embodiments of the present disclosure.

As shown in FIG. 3, the buffer unit 120 includes a first buffer (i.e., Buffer) 121 and a second buffer 122.

The first buffer 121 is configured to perform a first operation. The second buffer 122 is configured to output the fourth matrix required for a single calculation to the first computation unit 111 each time the first buffer 121 outputs the second matrix to the first computation unit 111 to perform the single calculation.

As some implementations, the second buffer 122 may be configured to obtain the fourth matrix from a storage unit external to the computation circuit 100.

It can be understood that the number of elements in the fourth matrix is also less than or equal to the calculation parallelism of the first computation unit 111. For example, the number of elements in the fourth matrix is equal to the number of elements in the second matrix, and both the number of elements in the fourth matrix and the number of elements in the second matrix are equal to the calculation parallelism of the first computation unit 111.

In the above embodiment, when the first computation unit 111 requires two matrices to perform calculations, the first buffer 121 and the second buffer 122 in the buffer unit 120 respectively output one matrix and the other matrix of the two matrices to the first computation unit 111. In this way, the possibility of calculation errors caused by the same buffer outputting two matrices to the first computation unit 111 can be avoided, thereby improving calculation accuracy. In addition, this can reduce the processing load on the buffers 121 and 122, thereby reducing the possibility of failure of the buffer unit 120, and thus enhancing the reliability of the computation circuit 100.

FIG. 4 is a structural schematic diagram of a streaming-based computation circuit according to further embodiments of the present disclosure.

As shown in FIG. 4, the streaming-based computation circuit 100 further includes a first selection unit 130, a second selection unit 140, and a third selection unit 150.

The first selection unit 130 includes a first input end 131, a second input end 132, a first output end 133 and a second output end 134.

Here, the first input end 131 may be configured to be connected to any one of the first output end 133 and the second output end 134, the second input end 132 is configured to be connected to the first output end 133, and the first output end 133 is configured to be connected to the input end of the buffer unit 120.

For example, referring to FIG. 4, the first output end 133 is configured to be connected to the input end of the first buffer 121 in the buffer unit 120.

The second selection unit 140 includes a third input end 141, a fourth input end 142, a third output end 143 and a fourth output end 144.

Here, the third input end 141 is configured to be connected to the output end of the first group of computation units 110a, and may also be configured to be connected to any one of the third output end 143 and the fourth output end 144. The fourth input end 142 is configured to be connected to the second output end 134 in the first selection unit 130 and is also configured to be connected to the third output end 143. The third output end 143 is configured to be connected to the input end of the second group of computation units 110b.

The third selection unit 150 includes a fifth input end 151, a fifth output end 152 and a sixth output end 153.

Here, the fifth input end 151 is configured to be connected to the output end of the second group of computation units 110b, and may also be configured to be connected to any one of the fifth output end 152 and the sixth output end 153. The fifth output end 152 is configured to be connected to the second input end 132 in the first selection unit 130.

The computation circuit 100 shown in FIG. 4 may be configured in different streaming paths for different calculation requirements, so that different groups of computation units 110 perform calculations, or the first group of computation units 110a and the second group of computation units 110b perform calculations in different sequences.

For example, the first input end 131 of the first selection unit 130 may be configured to be connected to the first output end 133, and the third input end 141 of the second selection unit 140 may be configured to be connected to the fourth output end 144. In this case, among the first group of computation units 110a and the second group of computation units 110b, only the first group of computation units 110a performs calculations, while the second group of computation units 110b does not perform calculations, and the calculation results are outputted through the fourth output end 144.

For another example, the first input end 131 of the first selection unit 130 may be configured to be connected to the second output end 134, and the fourth input end 142 of the second selection unit 140 may be configured to be connected to the third output end 143. In this case, among the first group of computation units 110a and the second group of computation units 110b, only the second group of computation units 110b perform calculations, while the first group of computation units 110a does not perform calculations, and the calculation results are outputted through the sixth output end 153.

For yet another example, the first input end 131 of the first selection unit 130 may be configured to be connected to the first output end 133, the third input end 141 of the second selection unit 140 may be configured to be connected to the third output end 143, and the fifth input end 151 of the third selection unit 150 may be configured to connected to the sixth output end 153. In this case, both the first group of computation units 110a and the second group of computation units 110b perform calculations, and the first group of computation units 110a performs calculations first and the second group of computation units 110b performs calculations later, and the calculation results are outputted through the sixth output end 153.

For still another example, the first input end 131 of the first selection unit 130 may be configured to be connected to the second output end 134, the second input end 132 may be configured to be connected to the first output end 133, the fourth input end 142 of the second selection unit 140 may be configured to be connected to the third output end 143, the third input end 141 may be configured to be connected to the fourth output end 144, and the fifth input end 151 of the third selection unit 150 may be configured to be connected to the fifth output end 152. In this case, both the first group of computation units 110a and the second group of computation units 110b perform calculations, and the second group of computation units 110b performs calculations first and the first group of computation units 110a performs calculations later, and the calculation results are outputted through the fourth output end 144.

In the computation circuit 100 of the above embodiment, by configuring the connection modes between the respective input ends and the output ends of the first selection unit 130, the second selection unit 140 and the third selection unit 150, the computation circuit 100 may have different streaming paths, which allows different groups of computation units 110 to perform calculations, or the first group of computation units 110a and the second group of computation units 110b to perform calculations in different sequences. By increasing the number of configurable streaming paths of the computation circuit 100, the computation circuit 100 may complete the calculations of some artificial intelligence algorithms in fewer rounds. In this way, it helps to further improve computational efficiency.

It should be understood that “a round” here refers to a process where the computation circuit 100 retrieves data to be calculated from a storage unit external to the computation circuit 100 and outputs the calculation result to the storage unit. In the same round, the streaming paths of the computation circuit 100 remain unchanged, while in different rounds, the streaming paths of the computation circuit 100 may be the same or different.

It should also be understood that each computation unit 111 may be configured to perform multiple calculations in one round, and the buffer unit 120 may also be configured to perform multiple first operations in one round.

In some embodiments, the buffer unit 120 (e.g., the first buffer 121) is configured to perform the second operation under the condition that the computation circuit 100 follows a streaming path where the first group of computation units 110a performs calculations first, and the second group of computation units 110b performs the calculations later.

In other embodiments, the buffer unit 120 (e.g., the first buffer 121) is configured to perform the first operation under the condition that the computation circuit 100 follows a streaming path where the second group of computation units 110b performs calculations first, and the first group of computation units 110a performs the calculations later.

It should be understood that the selection units 130 to 150 within the computation circuit 100, along with their respective input and output ends, are presented solely for illustrative purposes and should not be construed as limiting. In the case where the computation circuit 100 includes more groups of computation units 110, in order to further increase the number of streaming paths, the computation circuit 100 may also include other selection units, and the selection units 130 to 150 may also include more input ends and output end. For example, the third output end 143 of the second selection unit 140 may be connected to the input end of the second group of computation units 110b through other groups of computation units and other selection units not shown in FIG. 4. For another example, the third input end 141 of the second selection unit 140 may be connected to the output end of the first group of computation units 110a through other groups of computation units and other selection units not shown in FIG. 4.

It should also be understood that any input end of the selection unit is only connected to one output end corresponding to the selection unit under a certain streaming path, and any output end of the selection unit is only connected to one input end corresponding to the selection unit under a certain streaming path. In other words, in any streaming path, the input end of the selection unit will not be connected to two output ends at the same time, and the output end of the selection unit will not be connected to two input ends at the same time.

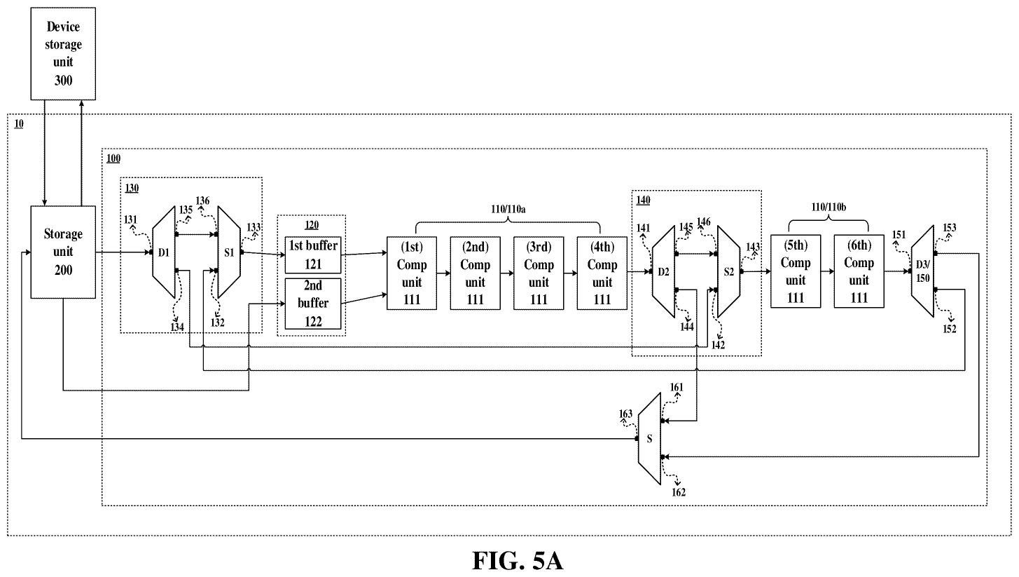

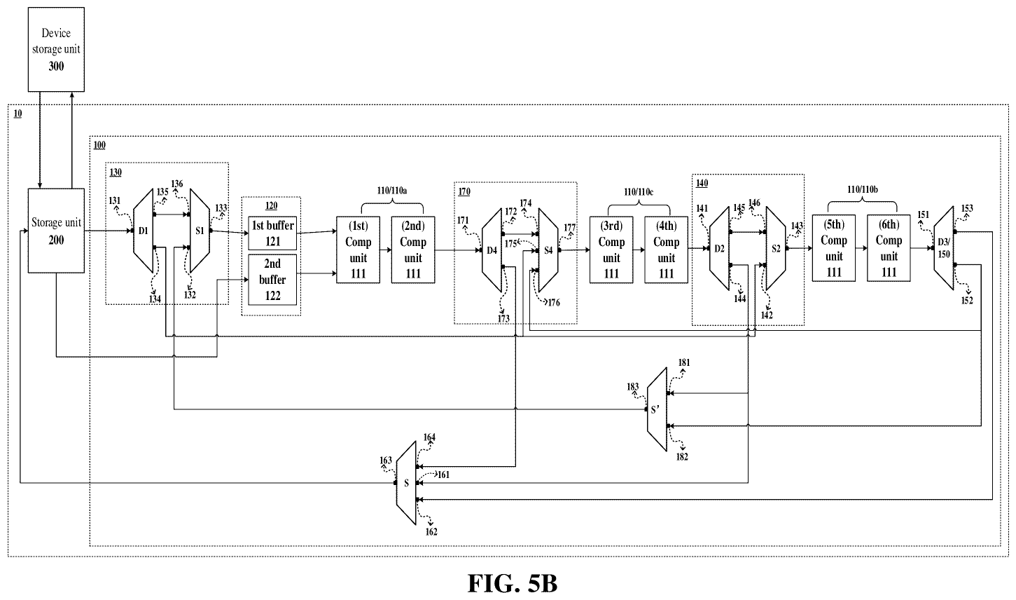

The implementation of the selection units 130 to 150 in some embodiments of the present disclosure will be described below with reference to FIG. 5A. FIG. 5A is a structural schematic diagram of a streaming-based computation circuit according to some embodiments of the present disclosure.

As shown in FIG. 5A, the first selection unit 130 includes a first distributor D1 and a first selector S1.

The first distributor D1 includes a first input end 131, a second output end 134 and a first intermediate output end 135. The first input end 131 may be configured to be connected to any one of the second output end 134 and the first intermediate output end 135.

The first selector S1 includes a first intermediate input end 136, a second input end 132 and a first output end 133. The first intermediate input end 136 is configured to be connected to the first intermediate output end 135, and the first output end 133 may be configured to be connected to any one of the first intermediate input end 136 and the second input end 132.

When the first input end 131 is connected to the first intermediate output end 135 and the first intermediate input end 136 is connected to the first output end 133, the first input end 131 is connected to the first output end 133.

As shown in FIG. 5A, the second selection unit 140 includes a second distributor D2 and a second selector S2.

The second distributor D2 includes a third input end 141, a second intermediate output end 145 and a fourth output end 144. The third input end 141 may be configured to be connected to any one of the second intermediate output end 145 and the fourth output end 144.

The second selector S2 includes a fourth input end 142, a second intermediate input end 146 and a third output end 143. The second intermediate input end 146 is configured to be connected to the second intermediate output end 145, and the third output end 143 may be configured to be connected to any one of the fourth input end 142 and the second intermediate input end 146.

When the third input end 141 is connected to the second intermediate output end 145 and the second intermediate input end 146 is connected to the third output end 143, the third input end 141 is connected to the third output end 143.

As shown in FIG. 5A, the third selection unit 150 includes a third distributor D3. The third distributor D3 includes a fifth input end 151, a fifth output end 152 and a sixth output end 153.

So far, the implementation of the selection units 130 to 150 has been described.

In some embodiments, referring to FIG. 5A, the computation circuit 100 further includes a selector S. The selector S may include an input end 161, an input end 162, and an output end 163. The output end 163 may be configured to be connected to any one of the input end 161 and the input end 162. The input end 161 may be configured to be connected to the fourth output end 144 of the second selection unit 140, and the input end 162 may be configured to be connected to the sixth output end 153 of the third selection unit 150.

By configuring the selector S within the computation circuit 100, once either the first group of computation units 110a or the second group of computation units 110b completes the calculations, through the selector S, the calculation results generated by the first group of computation units 110a or the second group of computation units 110b are outputted to the outside of the computation circuit 100, or to other groups of computation units not shown in the computation circuit 100 to continue calculation.

As some implementations, as shown in FIG. 5A, the output end 163 may be connected to the storage unit 200 external to the computation circuit 100. The storage unit 200 may be, but is not limited to, a static random access memory (Static Random Access Memory, SRAM).

In this case, the calculation results outputted by the first group of computation units 110a or the second group of computation units 110b may be outputted to the storage unit 200 for storage through the selector S.

For example, referring to FIG. 5A, the first input end 131 of the first selection unit 130 may be configured to be connected to the storage unit 200 to obtain data to be calculated from the storage unit 200.

For another example, the input end of the second buffer 122 may be configured to be connected to the storage unit 200 to obtain data to be calculated from the storage unit 200 (e.g., the fourth matrix).

As some implementations, as shown in FIG. 5A, the storage unit 200 and the computation circuit 100 are located in the artificial intelligence chip 10. The artificial intelligence chip 10 may be installed in electronic device. The electronic device may include a device storage unit 300. The device storage unit 300 may be, but is not limited to, Double Data Rate Synchronous Dynamic Random Access Memory (DDR SDRAM).

In this case, the storage unit 200 may be configured to obtain the data to be calculated from the device storage unit 300 and output the calculation results to the device storage unit 300.

It may be understood that in the case where the computation circuit 100 includes other groups of computation units and other selection units, the computation circuit 100 may also include other distributors other than the distributors D1 to D3, and other selectors other than the selectors S1 and S2. In addition, the distributors D1-D3 and the selectors S1-S2 may also include input ends and output ends other than the input ends and output ends shown in FIG. 5A, and the input ends and output ends of the distributors D1-D3 and the selectors S1-S2 shown in FIG. 5A may also be connected to other components. This is explained below with reference to the example of FIG. 5B.

FIG. 5B is a structural schematic diagram of a streaming-based computation circuit according to some embodiments of the present disclosure.

In the computation circuit 100 shown in FIG. 5B, in addition to the first group of computation units 110a and the second group of computation units 110b, the multiple groups of computation units 110 also include a third group of computation units 110c. FIG. 5B schematically shows that the first group of computation units 110a, the second group of computation units 110b and the third group of computation units 110c each include 2 computation units 111.

As shown in FIG. 5B, in the case of three groups of computation units 110, the computation circuit 100 may further include a fourth selection unit 170. The fourth selection unit 170 may include a fourth distributor D4 and a fourth selector S4.

The fourth distributor D4 includes an input end 171, an output end 172 and an output end 173. The input end 171 is configured to be connected to the output end of the first group of computation units 110a, and may be configured to be connected to any one of the output end 172 and the output end 173.

The fourth selector S4 includes an input end 174, an input end 175, an input end 176 and an output end 177.

The input end 174 is configured to be connected to the output end 172. The input end 175 is configured to be connected to the second output end 134 of the first distributor D1, that is, the second output end 134 is connected to both the input end 175 and the fourth input end 142 of the second selector S2. The input end 176 is configured to be connected to the fifth output end 152 of the third distributor D3, that is, the fifth output end 152 is connected to both the input end 176 and the second input end 132 of the first selector S1.

The output end 177 is configured to be connected to the input end of the third group of computation units 110c, and may also be configured to be connected to any one of the input ends 174, 175 and 176. The output end of the third group of computation units 110c is configured to be connected to the third input end 141 of the second selection unit 140.

That is, in the example shown in FIG. 5B, the third input end 141 of the second selection unit 140 is connected to the output end of the first group of computation units 110a through the third group of computation units 110c and the fourth selection unit 170 in sequence.

In some embodiments, as shown in FIG. 5B, the selector S may also include an input end 164. The output end 163 may be configured to be connected to any one of the input ends 161, 162, and 164. The input end 164 is configured to be connected to the output end 173. In this way, after the first group of computation units 110a, the second group of computation units 110b, or the third group of computation units 110c complete the calculation, through the selector S, the calculation results generated by the first group of computation units 110a, the second group of computation units 110b, or the third group of computation units 110c are outputted to the outside of the computation circuit 100, or to other groups of computation units not shown in the computation circuit 100 to continue calculation.

In some embodiments, as shown in FIG. 5B, the computation circuit 100 may further include a selector S′, which includes an input end 181, an input end 182, and an output end 183.

The input end 181 may be configured to be connected to the fourth output end 144 of the second distributor D2. The input end 182 may be configured to be connected with the fifth output end 152 of the third distributor D3.

The output end 183 may be configured to be connected to the second input end 132 of the first selector S1, and may be configured to be connected to any one of the input end 181 and the input end 182.

In other words, in the example shown in FIG. 5B, the fifth output end 152 may be connected to the second input end 132 through the selector S′. That is, when the output end 183 is connected to the input end 182, the fifth output end 152 is connected to the second input end 132.

By setting the selector S′, the calculation results generated by the second group of computation units 110b or the third group of computation units 110c may be outputted to the first group of computation units 110a to continue calculation.

It can be seen from the example of FIG. 5B that in the case where the computation circuit 100 includes three or more groups of computation units 110, by setting more selection units (such as selectors and distributors), the computation circuit 100 may have more streaming paths, thereby enabling the computation circuit 100 to complete the calculations of some artificial intelligence algorithms in fewer rounds, thus further enhancing computational efficiency.

In some embodiments, the first group of computation units 110a and the second group of computation units 110b include computation units configured to perform the same type of artificial intelligence calculations, and further include computation units configured to perform different types of artificial intelligence calculations.

By providing computation units configured to perform the same type of artificial intelligence calculations in the first group of computation units 110a and the second group of computation units 110b, the computation circuit 100 may be enabled to complete the calculations of some artificial intelligence algorithms in fewer rounds, thereby enhancing computational efficiency.

As some implementations, the same type of artificial intelligence calculation includes linear calculations. That is, both the first group of computation units 110a and the second group of computation units 110b include the computation unit 111 configured to perform linear calculations.

In some embodiments, referring to FIG. 5A, the first group of computation units 110a includes a first computation unit 111, a second computation unit 111, a third computation unit 111 and a fourth computation unit 111. The first computation unit 111 is configured to perform kernel function calculations. The second computation unit 111 is configured to perform activation function calculations. The third computation unit 111 is configured to perform linear calculations. The fourth computation unit 111 is configured to perform pooling calculations.

In other embodiments, referring to FIG. 5A, the second group of computation units 110b includes a fifth computation unit 111 and a sixth computation unit 111. The fifth computation unit 111 is configured to perform linear calculations. The sixth computation unit is configured to perform reduction function calculations.

In some embodiments, the first group of computation units 110a includes the above-mentioned first, second, third and fourth computation units 111, 111, 111, and the second group of computation units 110b includes the above-mentioned third computation unit 111. The fifth computation unit 111 and the sixth computation unit 111. This enables the computation circuit 100 to complete the calculations of some artificial intelligence algorithms in fewer rounds, thereby enhancing computational efficiency.

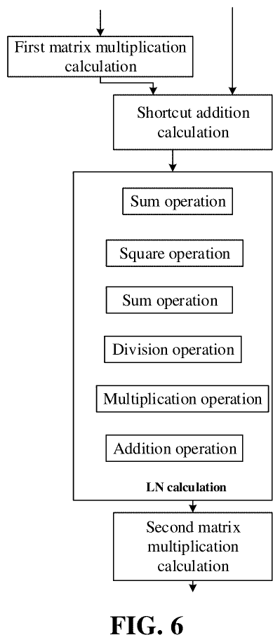

In order to facilitate understanding, the following is explained in conjunction with the currently widely used transformer (i.e., Transformer) algorithm based on the self-attention mechanism. FIG. 6 schematically shows some calculations in the Transformer algorithm.

As shown in FIG. 6, the Transformer algorithm includes four calculations as shown in FIG. 6. These four calculations are the first matrix multiplication calculation, Shortcut addition calculation, and layer normalization (Layer Normalization, LN) calculation and the second matrix multiplication calculation in the order they need to be performed. The LN calculation includes (e.g., include in sequence) a first sum operation, a square operation, a second sum operation, a division operation, a multiplication operation, and an addition operation (that is, add).

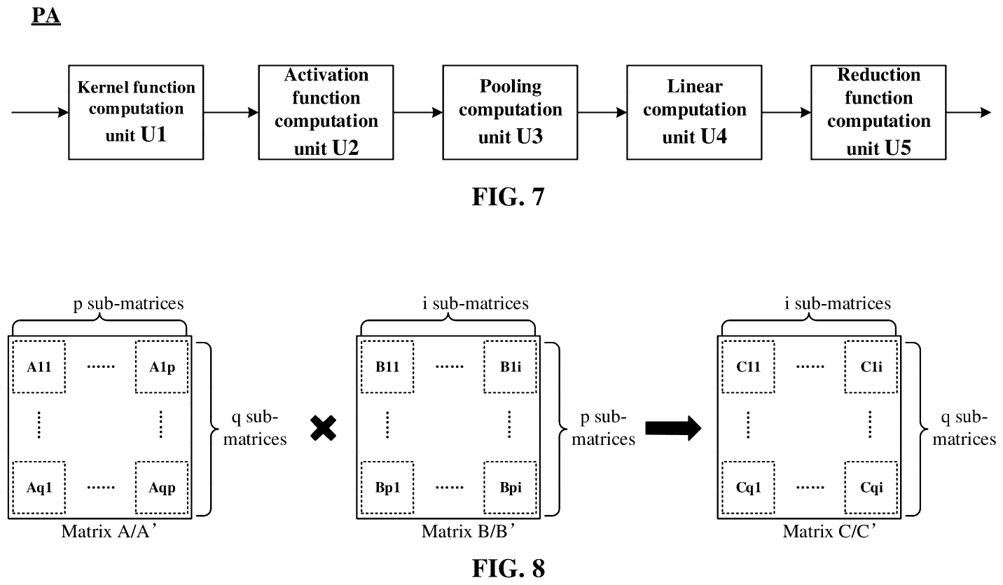

FIG. 7 shows a structural schematic diagram of a streaming-based computation circuit in the related art.

As shown in FIG. 7, the streaming-based computation circuit PA includes a kernel function computation unit U1, an activation function computation unit U2, a pooling computation unit U3, a linear computation unit U4, and a reduction function computation unit U5 that are connected in sequence.

It can be understood that the computation circuit PA only includes a streaming path in which the kernel function computation unit U1, the activation function computation unit U2, the pooling computation unit U3, the linear computation unit U4 and the reduction function computation unit U5 are connected in sequence.

If the computation circuit PA shown in FIG. 7 is used to complete the four calculations shown in FIG. 6, these four calculations need to be divided into three consecutive rounds.

In the first round, the computation circuit PA completes the first matrix multiplication calculation, the Shortcut addition calculation and the first part of the LN calculation. For example, first, the kernel function computation unit U1 performs the first matrix multiplication calculation; then, the linear computation unit U4 performs the Shortcut addition calculation; finally, the reduction function computation unit U5 performs the first part of the LN calculation.

In the second round, the computation circuit PA completes the second part of the LN calculation. For example, at least a part of the operators in the computation units U1-U5 perform operations to complete the remaining part in the LN calculation.

In the third round, the computation circuit PA completes the second matrix multiplication calculation. Specifically, the second matrix multiplication calculation is completed by the kernel function computation unit U1.

Compared with the computation circuit PA, if the computation circuit 100 shown in FIG. 5A is used to complete the four calculations shown in FIG. 6, it is only necessary to divide the four computation units into two successive rounds.

In the first round, the streaming path of the computation circuit 100 is configured such that the first group of computation units 110a performs calculation first and the second group of computation units 110b performs the calculation later. The computation circuit 100 completes the first matrix multiplication calculation, the Shortcut addition calculation and the first part of the LN calculation.

It can be understood that compared with the computation circuit PA in the related art, the streaming path of the computation circuit 100 in the first round configuration mode additionally includes a linear computation unit between the activation function computation unit and the pooling computation unit. In this case, the first part of the LN calculation completed by the computation circuit 100 in the first round is more than that completed by the computation circuit PA in the first round.

In the second round, the streaming path of the computation circuit 100 is configured such that the second group of computation units 110b performs calculation first and the first group of computation units 110a performs the calculation later. In this case, the computation circuit 100 can complete the second part of the LN calculation and the second matrix multiplication calculation.

It can be seen from the above description that since the computation circuit 100 can be configured in different streaming paths in different rounds, the computation circuit 100 shown in FIG. 5A can be used to complete part of the calculations in the Transformer algorithm in fewer rounds, thereby enhancing the computational efficiency of the Transformer algorithm.

The structure of the streaming-based computation circuit 100 according to the embodiment of the present disclosure has been clearly explained above with reference to FIGS. 3 to 5B.

Next, the streaming-based computation circuit and/or computation method of the embodiments of the present disclosure will be further described in conjunction with some embodiments.

In some embodiments, the number of elements in the second matrix obtained by concatenation in the first operation is equal to the calculation parallelism of the first computation unit 111. For example, the calculation parallelism of the first computation unit 111 is 256B, and the number of elements in the first matrix is 64. In the case where M is equal to 4, the number of elements in the second matrix is equal to the calculation parallelism of the first computation unit 111.

The number of elements in the second matrix is equal to the calculation parallelism of the first computation unit 111, which can maximize the utilization rate of the operators in the first computation unit 111, thereby enhancing the computational efficiency.

In some embodiments, N is an integer not less than M. For example, N is equal to M; for another example, N is greater than M. In this way, the buffer unit 120 can receive the M first matrices in the next first operation during consecutively outputting the second matrix to the first computation unit 111 for N times, so that after the second matrix in the previous first operation is consecutively outputted to the first computation unit 111 for N times, the second matrix in the next first operation is directly outputted to the first computation unit 111 without additional waiting. In this way, the computational efficiency can be further improved.

As some implementations, N equals M. In this way, without receiving an additional first matrix (i.e., the first matrix in the next first operation), the buffer unit 120 just receives the M first matrices in the next first operation during consecutively outputting the second matrix in the previous first operation to the first computation unit 111 for N times. In this way, the first computation unit 111 may output the final result based on the intermediate results obtained in fewer calculations. In this way, the storage space required for temporarily storing intermediate results inside the first computation unit 111 can be reduced, thereby reducing the manufacturing cost of the first computation unit 111 and further the manufacturing cost of the computation circuit 100.

For better understanding, the following description takes the matrix multiplication calculation performed by the first computation unit 111 as an example. FIG. 8 is a schematic diagram of matrices required to perform matrix multiplication calculations in accordance with some embodiments of the present disclosure.

It is assumed that the first computation unit 111 needs to perform matrix multiplication calculation on the matrix A and the matrix B shown in FIG. 8 to obtain the matrix C. The number of elements of each of matrix A and matrix B is greater than the calculation parallelism of the first computation unit 111.

In this case, matrix A and matrix B can be divided into multiple sub-matrices in the manner shown in FIG. 8, and the number of elements in each sub-matrix is equal to the calculation parallelism of the first computation unit 111. The first computation unit 111 can obtain a result of multiplying a sub-matrix in matrix A and a sub-matrix in matrix B in each calculation.

For example, the calculation parallelism of the first computation unit 111 is 256B. In this case, each sub-matrix in matrix A and matrix B is a 16 (row)×16 (column) matrix.

In some embodiments, the number of one or more of row-direction elements of matrix A and matrix B is not divisible by the number of row-direction elements of a sub-matrix. In other embodiments, the number of one or more of column-direction elements of matrix A and matrix B is not divisible by the number of column-direction elements of a sub-matrix.

In these cases, matrix A (or matrix B) may be zero-padded to obtain matrix A′ (or matrix B′), and matrix multiplication calculation may be performed on matrix A′ and/or matrix B′ to obtain matrix C ‘.

It should be understood that the number of elements of matrix A’ and matrix B′ in the row direction may be divisible by the number of elements of a sub-matrix in the row direction, and the number of elements in the column direction may also be divisible by the number of elements of a sub-matrix in the column direction.

For convenience of explanation, the following description is based on matrices A, B, and C, without considering the conditions of matrices A′, B′, and C′.

As shown in FIG. 8, the divided matrix A includes p sub-matrices in the row direction and q sub-matrices in the column direction. The divided matrix B includes i sub-matrices in the row direction and p sub-matrices in the column direction. The calculated matrix C includes i sub-matrices in the row direction and q sub-matrices in the column direction. p, q, and i can all be integers greater than or equal to 2.

FIG. 8 schematically shows the four sub-matrices A11, A1p, Aq1, and Aqp after the matrix A is divided and the four sub-matrices B11, B1i, Bp1, and Bpi after the matrix B is divided. Correspondingly, FIG. 8 also schematically shows four sub-matrices C11, C1i, Cq1 and Cqi corresponding to matrix C. Here, in the last two digits of each sub-matrix symbol, the first digit indicates which row of the corresponding matrix this sub-matrix is in, and the last digit indicates which column of the corresponding matrix this sub-matrix is in.

According to the calculation rules of matrix multiplication, it is necessary to first multiply the p sub-matrices in the x-th row of matrix A and the p sub-matrices in the y-th column of matrix B in a one-to-one correspondence to obtain p intermediate results. Then, the p intermediate results are added to obtain a sub-matrix of the x-th row and y-th column of matrix C. In other words, the first computation unit 111 needs to perform p calculations and temporarily store p intermediate results internally to output a sub-matrix in the matrix C as the final result.

The following description is based on the example where each sub-matrix in matrix A is a second matrix used by the first buffer 121 in a first operation, and each sub-matrix in matrix B is a fourth matrix obtained by the second buffer 122 from the storage unit 200 external to the computation circuit 100.

In one first operation, the first buffer 121 may consecutively output a sub-matrix in matrix A to the first computation unit 111 for N times to be multiplied by N sub-matrices in matrix B respectively.

In this case, the first computation unit 111 can obtain and temporarily store an intermediate result corresponding to each of the N sub-matrices in the matrix C through a first operation of the first buffer 121. Through performing the first operation p times, the first computation unit 111 may obtain p intermediate results corresponding to each sub-matrix required for calculating the final result of the N sub-matrices. In other words, through performing the first operation p times, the first computation unit 111 may output N sub-matrices in the matrix C at one time based on the temporarily stored intermediate results.

It can be seen from the above description that when N is larger, the first computation unit 111 needs to temporarily store more intermediate results, which results in a larger storage space required for temporarily storing the intermediate results inside the first computation unit 111. Therefore, by setting N equal to M, some embodiments of the present disclosure can enhance computational efficiency while reducing the storage space required for temporarily storing intermediate results inside the first computation unit 111.

In some embodiments, the number of columns in the second matrix is K times that of the first matrix, where K is an integer greater than or equal to 2. In this case, each row element of the second matrix corresponds to K row elements from the first matrix.

For example, if assuming that the calculation parallelism of the first computation unit is 256B and that of each computation unit in the second group of computation units 110b is 64B, the first matrix may be an 8 (row)×8 (column) matrix, The second matrix may be a 16 (row)×16 (column) matrix obtained by concatenating four first matrices.

In this case, K is equal to 2, that is, any row element in the second matrix corresponds to 2 row elements in a certain first matrix. For example, the first row elements in the second matrix correspond to the first 2 row elements in the first matrix.

In the above embodiment, K row elements in the first matrix are used as one row element in the second matrix. In this way, the buffer unit 120 can sequentially concatenate the M first matrices in the order in which they are received to obtain the elements of each row of the second matrix, thereby simplifying the operation complexity of the buffer unit 120 concatenating the M first matrices to obtain the second matrix. In this way, the processing load on the buffer unit 120 can be reduced, thereby reducing the possibility of failure of the buffer unit 120, and thus enhancing the reliability of the computation circuit 100.

An embodiment of the present disclosure also provides an artificial intelligence chip, including the streaming-based computation circuit 100 of any of the above embodiments.

In some embodiments, referring to FIGS. 5A and 5B, the artificial intelligence chip also includes a storage unit 200 external to the computation circuit 100. The computation circuit 100 may be configured to obtain data to be calculated from the storage unit 200 and output the calculation results to the storage unit 200.

An embodiment of the present disclosure also provides an electronic device, including the artificial intelligence chip of any of the above embodiments. Electronic devices may be, but are not limited to, visual recognition devices and other devices that require artificial intelligence calculations.

Up to this point, various embodiments of the present disclosure have been described in detail. To avoid obscuring the concepts of the present disclosure, some details that are well known in the art have not been described. Based on the above description, those skilled in the art can completely understand how to implement the technical solution disclosed here.

Although some specific embodiments of the present disclosure have been described in detail through examples, those skilled in the art will understand that the above examples are for illustration only and are not intended to limit the scope of the disclosure. Those skilled in the art should understand that the above embodiments can be modified or some technical features can be equivalently replaced without departing from the scope and spirit of the present disclosure. The scope of the disclosure is defined by the appended claims.

What is claimed is:

1. A streaming-based computation circuit, comprising:
multiple groups of computation units, each group of computation units comprising one or more computation units, the multiple groups of computation units comprising a first group of computation units and a second group of computation units, the second group of computation units being configured to output a first matrix after each calculation; and
a buffer unit configured to perform one or more first operations, wherein the first operations comprise:
buffering M first matrices consecutively outputted by the second group of computation units for M times, wherein M is an integer greater than or equal to 2;
concatenating the M first matrices into a second matrix, a number of elements in the second matrix is not greater than a calculation parallelism of a first computation unit in the first group of computation units; and
consecutively outputting the second matrix to the first computation unit for N times to perform N calculations, wherein N is an integer greater than or equal to 2.

2. The computation circuit of claim 1, wherein the number of elements in the second matrix is equal to the calculation parallelism.

3. The computation circuit according to claim 1, wherein Nis an integer not less than M.

4. The computation circuit of claim 3, wherein N equals M.

5. The computation circuit of claim 1, wherein the buffer unit is further configured to perform a second operation, the second operation comprising:
directly outputting a received third matrix to the first computation unit to perform a calculation, wherein a number of elements in the third matrix is equal to the calculation parallelism.

6. The computation circuit of claim 1, wherein the buffer unit comprises:
a first buffer configured to perform the first operations; and
a second buffer configured to output a fourth matrix required for a single calculation to the first computation unit each time the first buffer outputs the second matrix to the first computation unit to perform the single calculation.

7. The computation circuit according to claim 1, further comprising:
a first selection unit comprising a first input end, a second input end, a first output end and a second output end, wherein:
the first input end is configured to be connected to any one of the first output end and the second output end,
the second input end is configured to be connected to the first output end,
the first output end is configured to be connected to an input end of the buffer unit;
a second selection unit comprising a third input end, a fourth input end, a third output end and a fourth output end, wherein:
the third input end is configured to be connected to an output end of the first group of computation units, and is further configured to be connected to any one of the third output end and the fourth output end,
the fourth input end is configured to be connected to the second output end, and is further configured to be connected to the third output end,
the third output end is configured to be connected to an input end of the second group of computation units; and
a third selection unit comprising a fifth input end, a fifth output end and a sixth output end, wherein:
the fifth input end is configured to be connected to an output end of the second group of computation units, and further configured to be connected to any one of the fifth output end and the sixth output end,
the fifth output end is configured to be connected to the second input end.

8. The computation circuit according to claim 5, further comprising:
a first selection unit comprising a first input end, a second input end, a first output end and a second output end, wherein:
the first input end is configured to be connected to any one of the first output end and the second output end,
the second input end is configured to be connected to the first output end,
the first output end is configured to be connected to an input end of the buffer unit;
a second selection unit comprising a third input end, a fourth input end, a third output end and a fourth output end, wherein:
the third input end is configured to be connected to an output end of the first group of computation units, and is further configured to be connected to any one of the third output end and the fourth output end,
the fourth input end is configured to be connected to the second output end, and is further configured to be connected to the third output end,
the third output end is configured to be connected to an input end of the second group of computation units; and
a third selection unit comprising a fifth input end, a fifth output end and a sixth output end, wherein:
the fifth input end is configured to be connected to an output end of the second group of computation units, and further configured to be connected to any one of the fifth output end and the sixth output end,
the fifth output end is configured to be connected to the second input end.

9. The computation circuit according to claim 6, further comprising:
a first selection unit comprising a first input end, a second input end, a first output end and a second output end, wherein:
the first input end is configured to be connected to any one of the first output end and the second output end,
the second input end is configured to be connected to the first output end,
the first output end is configured to be connected to an input end of the buffer unit;
a second selection unit comprising a third input end, a fourth input end, a third output end and a fourth output end, wherein:
the third input end is configured to be connected to an output end of the first group of computation units, and is further configured to be connected to any one of the third output end and the fourth output end,
the fourth input end is configured to be connected to the second output end, and is further configured to be connected to the third output end,
the third output end is configured to be connected to an input end of the second group of computation units; and
a third selection unit comprising a fifth input end, a fifth output end and a sixth output end, wherein:
the fifth input end is configured to be connected to an output end of the second group of computation units, and further configured to be connected to any one of the fifth output end and the sixth output end,
the fifth output end is configured to be connected to the second input end.

10. The computation circuit of claim 7, wherein:
the first selection unit comprises:
a first distributor comprising the first input end, the second output end and a first intermediate output end, the first input end being configured to be connected to any one of the second output end and the first intermediate output end, and
a first selector comprising a first intermediate input end, the second input end and the first output end, the first intermediate input end being configured to be connected to the first intermediate output end, the first output end being configured to be connected to any one of the first intermediate input end and the second input end;
the second selection unit comprises:
a second distributor comprising the third input end, a second intermediate output end and the fourth output end, the third input end being configured to be connected to any one of the second intermediate output end and the fourth output end, and
a second selector comprising the fourth input end, a second intermediate input end and the third output end, the second intermediate input end being configured to be connected to the second intermediate output end, the third output end being configured to be connected to any one of the fourth input end and the second intermediate input end;
the third selection unit comprises:
a third distributor comprising the fifth input end, the fifth output end, and the sixth output end.

11. The computation circuit of claim 1, wherein the first group of computation units and the second group of computation units comprise computation units configured to perform a same type of artificial intelligence calculations, and further comprise computation units configured to perform different types of artificial intelligence calculations.

12. The computation circuit of claim 11, wherein the same type of artificial intelligence calculations comprises a linear calculation.

13. The computation circuit of claim 11, wherein the first group of computation units comprises:
the first computation unit configured to perform a kernel function calculation;
a second computation unit configured to perform an activation function calculation;
a third computation unit configured to perform a linear calculation; and
a fourth computation unit configured to perform a pooling calculation.

14. The computation circuit of claim 11, wherein the second group of computation units comprises:
a fifth computation unit configured to perform a linear calculation; and
a sixth computation unit configured to perform a reduction function calculation.

15. The computation circuit according to claim 1, wherein a number of columns of the second matrix is K times a number of columns of the first matrix, K is an integer greater than or equal to 2, and each row of the second matrix comprises K-row elements of the first matrix.

16. A streaming-based computation method, comprising:
buffering M first matrices consecutively outputted by a second group of computation units of a streaming-based computation circuit for M times, M being an integer greater than or equal to 2;
concatenating the M first matrices into a second matrix, a number of elements in the second matrix being not greater than a calculation parallelism of a first computation unit in a first group of computation units of the computation circuit; and
consecutively outputting the second matrix to the first computation unit for N times to perform N calculation, N being an integer greater than or equal to 2;
wherein, the first group of computation units and the second group of computation units each comprise one or more computation units.

17. The method of claim 16, wherein the number of elements in the second matrix is equal to the calculation parallelism.

18. The method according to claim 16, wherein Nis an integer not less than M.

19. The method of claim 18, wherein N equals M.

20. An artificial intelligence chip, comprising:
the streaming-based computation circuit according to claim 1.
